(19) United States
(12) Patent Application Publication
(10) Pub. No.: US 2016/0355071 A1
(43) Pub. Date: Dec. 8, 2016

(54) AIR EXTRACTION SYSTEM AND METHOD FOR A MOTOR VEHICLE

(71) Applicant: FORD GLOBAL TECHNOLOGIES, LLC, Dearborn, MI (US)

(72) Inventors: Eric R. Yerke, Wayne, MI (US); Martha Elizabeth Nefcy, Dearborn, MI (US); Zhengyu Liu, Novi, MI (US); James R. Hurd, Canton, MI (US); Mitali Chakrabarti, Canton, MI (US); Guadalupe Ramirez, Dearborn, MI (US)

(21) Appl. No.: 14/730,812

(22) Filed: Jun. 4, 2015

(51) Int. Cl. B60H 1/24

(52) U.S. Cl. CPC B60H 1/248

(57) ABSTRACT

An air extraction system is provided for a motor vehicle. That air extraction system includes a trim air discharge outlet, an extractor and an extractor duct extending between the trim air discharge outlet and the extractor. The extractor duct is tuned to dissipate duct noise at at least one particular duct noise frequency characteristic of the extractor duct.

### TECHNICAL FIELD

This document relates generally to the motor vehicle field and, more particularly, to an air extraction system and method incorporating a tuned extractor duct for improved airflow and dissipation of noise, vibration and harshness.

### BACKGROUND

In order to allow proper airflow inside a passenger cabin of a motor vehicle and to control window fogging as well as ease of door closing effort, it is known to provide air extractors. Such air extractors may be located in the vehicle cabin sheet metal to allow air to exit to the ambient. More specifically, in order to permit airflow from the passenger compartment to the extractors, holes are provided in the package tray. These holes allow the air to flow from the motor vehicle passenger cabin into open spaces in the body side sheet metal and out of the extractors into the ambient environment. The space that the air flows through is not a defined space. Thus, when noise, vibration and harshness (NVH) concerns are identified in a motor vehicle, sealing material is inserted into the open spaces, potentially blocking the airflow path and reducing the effectiveness of the extractors. Since the airflow needs the open spaces to flow properly to the extractors and NVH needs tend to block sound being transmitted through the open spaces, the two functions are diametrically opposed to each other.

This document relates to a new and improved air extraction system and related method incorporating an extractor duct providing a sealed and dedicated air extraction pathway between the trim air discharge outlet within the passenger compartment and the extractor. Significantly, that duct is tuned to dissipate duct noise at at least one particular duct noise frequency characteristic of the extractor duct. In this way, improved airflow for air extraction and enhanced dissipation of NVH are both provided. Accordingly, the air extraction system and method disclosed in this document both represent a significant advance in the art.

### SUMMARY

In accordance with the purposes and benefits described herein, an air extraction system is provided for a motor vehicle. That extraction system comprises: (a) a trim air discharge outlet, (b) an extractor, and (c) an extractor duct extending between the trim air discharge outlet and the extractor. That extractor duct is tuned to dissipate duct noise at at least one particular duct noise frequency characteristic of the extractor duct.

More specifically, the extractor duct includes a first expansion chamber sized and shaped to dissipate duct noise at a first duct noise frequency. In one possible embodiment, the extractor duct further includes a second expansion chamber sized and shaped to dissipate duct noise at a second duct noise frequency. In yet another possible embodiment, the extractor duct includes a third expansion chamber sized and shaped to dissipate duct noise at a third duct noise frequency. The third expansion chamber is downstream from the second expansion chamber and the second expansion chamber is downstream from the first expansion chamber.

The first expansion chamber has a length L₁, the second expansion chamber has a length L₂ and the third expansion chamber has a length L₃ where L₁≠L₂≠L₃. In one possible embodiment, L₁>L₂>L₃. In another possible embodiment, L₁>L₃>L₂. In yet another possible embodiment, L₂>L₁>L₃. In still another possible embodiment, L₂>L₃>L₁. In still another possible embodiment, L₃>L₂>L₁. In yet another, L₃>L₁>L₂. In any of the embodiments, the trim air discharge outlet may be provided in a package tray of the motor vehicle.

In accordance with an additional aspect, a method of air extraction from a motor vehicle is provided. That method may be broadly described as comprising the steps of: (a) providing an extractor duct extending from a trim air discharge outlet to an extractor of the motor vehicle and (b) tuning that extractor duct to dissipate duct noise at at least one duct noise frequency characteristic of the extractor duct.

The method may further include the step of providing a first expansion chamber in the extractor duct wherein the first expansion chamber is sized and shaped to dissipate duct noise at a first duct noise frequency.

In addition, the method may further include the step of providing a second expansion chamber in the extractor duct wherein the second expansion chamber is sized and shaped to dissipate duct noise at a second duct noise frequency.

Still further, the method may include the step of providing a third expansion chamber in the extractor duct wherein the third expansion chamber is sized and shaped to dissipate duct noise at a third duct noise frequency.

The method may also include the step of providing the first expansion chamber with a length L₁, the second expansion chamber with a length L₂ and the third expansion chamber with a length L₃ wherein L₁≠L₂≠L₃.

In the following description, there are shown and described several preferred embodiments of the air extraction system and related method. As it should be realized, the system and method are capable of other, different embodiments and their several details are capable of modification in various, obvious aspects all without departing from the system and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the air extraction system and together with the description serve to explain certain principles thereof. In the drawing figures:

FIG. 1 is a perspective view of a motor vehicle incorporating the air extraction system that is the subject matter of this document.

FIG. 2 is a detailed perspective view of the extractor duct of the air extraction system illustrated in FIG. 1 showing the inlet of the duct that is connected to the trim air discharge outlet within the passenger cabin of the motor vehicle at the package tray, and the outlet that is connected to the extractor as well as two expansion chambers sized and shaped to dissipate duct noise at two different duct noise frequencies.

FIG. 3 is a schematic illustration of yet another embodiment of air extraction system incorporating an extractor duct with three different expansion chambers.

FIG. 4 is a graph of sound transmission loss versus frequency for one possible embodiment of the air extraction system incorporating an extractor duct with three expansion chambers as illustrated in FIG. 3.

Reference will now be made in detail to the present preferred embodiments of the air extraction system, examples of which are illustrated in the accompanying drawing figures.

### DETAILED DESCRIPTION

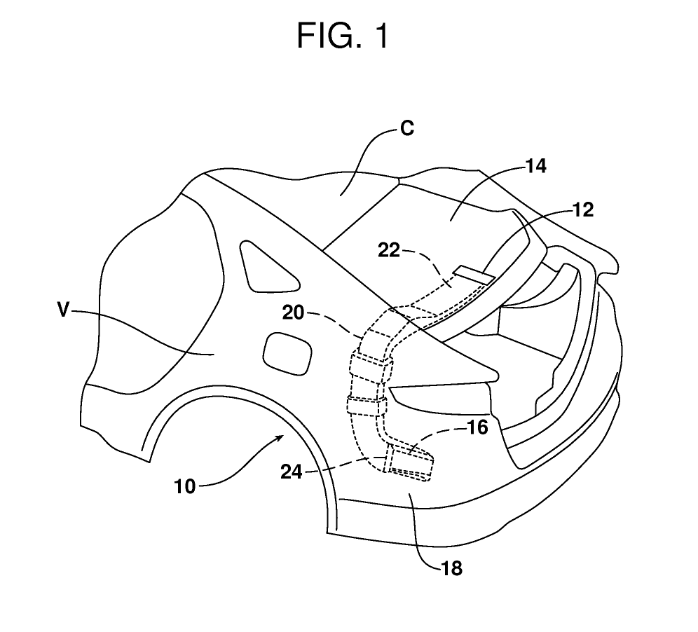

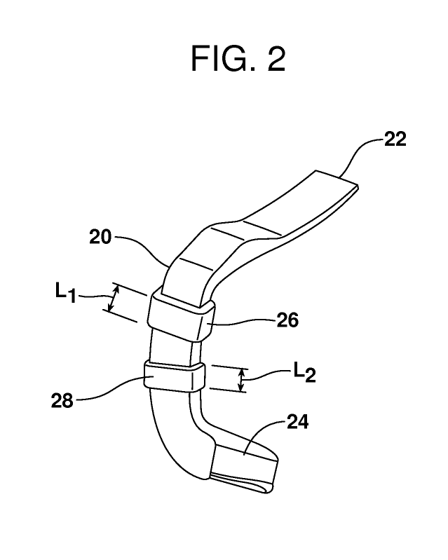

Reference is now made to FIGS. 1 and 2 illustrating a first embodiment of air extraction system 10 for a motor vehicle V. The air extraction system 10 includes a trim air discharge outlet 12 provided in the package tray 14 of the passenger cabin C and an extractor 16 provided in the sheet metal 18 at the rear of the motor vehicle V. An extractor duct, generally designated by reference numeral 20, extends between the trim air discharge outlet 12 and the extractor 16 to provide a dedicated flow pathway for air being extracted from the passenger cabin C of the motor vehicle. Such an air extraction pathway functions to allow proper airflow inside the passenger cabin C, allow better control of window fogging and allow ease of door closing effort when all but one of the windows and doors of the vehicle are closed.

The extractor duct 20 includes an inlet 22 in communication with the trim air discharge outlet 12 in the package tray 14 and an outlet 24 in communication with the extractor 16. Further, in the embodiment illustrated in FIG. 2, the extractor duct 20 includes two different expansion chambers 26, 28. In the illustrated embodiment, the first expansion chamber 26 is provided upstream from the second expansion chamber 28. Further, the first expansion chamber has a length L₁ while the second expansion chamber has a length L₂ where L₁≠L₂. Thus, it should be appreciated that the two expansion chambers 26, 28 are sized and shaped to dissipate duct noise at two different duct noise frequencies.

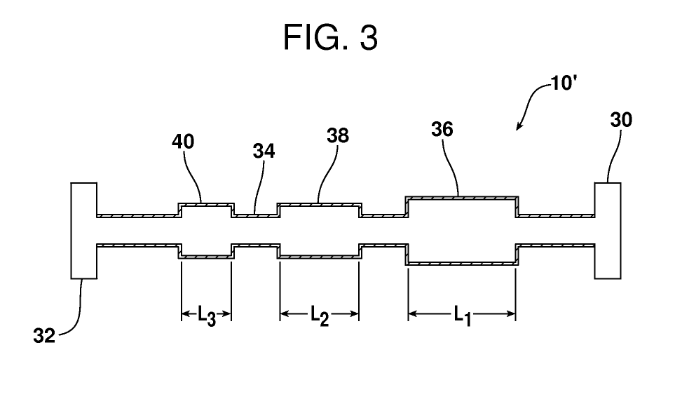

Reference is now made to FIG. 3 which schematically illustrates a second embodiment of air extraction system 10′. That second embodiment 10′, includes a trim air discharge outlet 30, an extractor 32 and an extractor duct 34 extending between the trim air discharge outlet and the extractor. The extractor duct 34 includes a first expansion chamber 36, a second expansion chamber 38 and a third expansion chamber 40. As illustrated, the third expansion chamber 40 is downstream from the second expansion chamber 38 which is downstream from the first expansion chamber 36.

As illustrated, the first expansion chamber 36 has a first length L₁ and a first cross-sectional area C₁. The second expansion chamber 38 has a second length L₂ and a second cross-sectional area C₂. The third expansion chamber 40 has a third length L₃ and a third cross-sectional area C₃ wherein L₁≠L₂≠L₃ and C₁≠C₂≠C₃. Expansion chamber length and cross-sectional area are varied intentionally in order to address different duct noise frequencies. The portions of the extractor duct 34 extending between the trim air discharge outlet 30, the extractor 32 and the expansion chambers 36, 38, 40 has a constant cross-sectional area C_{c} equal to the minimum duct cross-sectional area required to provide the desired airflow for extraction of air from the passenger cabin C. The cross-sectional area C_{c} is less than any of C₁, C₂ and C₃.

As should be appreciated, by providing the expansion chambers 30, 38, 40 in series, it is possible to address a wide range of duct noise frequencies. Sound transmission loss (TL) can be estimated by the following equation:

$$TL = 10 log [ 1 + \frac{1}{4} {\{ m - \frac{1}{m} \}}^{2} {sin}^{2} ( kL ) ]$$

$$Where , \\ m = {( \frac{y}{x} )}^{2} ;$$

$$kL = \frac{2 π fL}{c}$$

$$and$$

$$c = velocity$$

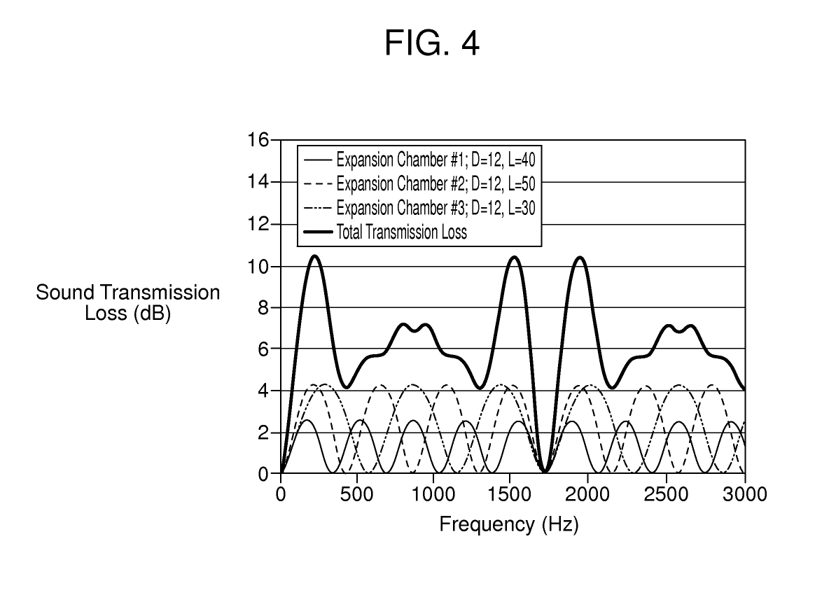

of sound in the air. Sound transmission losses are additive where multiple expansion chambers 36, 38 40 are provided in the extractor duct 34. Thus, for one hypothetical configuration of extractor system 10′, including three different expansion chambers 36, 38, 40, of indicated diameter D and length L, sound transmission loss can be represented by the graph illustrated in FIG. 4.

The disclosed air extraction system 10, 10′ functions in a method that may be broadly described as including the steps of: (a) providing an air extractor duct 20, 34 extending from a trim air discharge outlet 12, 30 to an extractor 16, 32 of a motor vehicle V and (b) tuning the extractor duct to dissipate duct noise at at least one particular duct noise frequency characteristic of the extractor duct.

In one possible embodiment, the method may further include the step of providing a first expansion chamber 36 in the extractor duct 34. That first expansion chamber 36 is sized and shaped to dissipate duct noise at a first duct noise frequency.

In yet another embodiment, the method may include the step of providing a second expansion chamber 38 in the extractor duct 34. That second expansion chamber 38 may be sized and shaped to dissipate duct noise at a second duct noise frequency.

In still another possible embodiment, the method may include the step of providing a third expansion chamber 40 in the extractor duct 34. That third expansion chamber 40 may be sized and shaped to dissipate duct noise at a third duct noise frequency. Thus, the method may also include the step of providing the first expansion chamber 36 with a length L₁, the second expansion chamber 38 with a length L₂ and the third expansion chamber 40 with a length L₃ where L₁≠L₂≠L₃.

In summary, numerous benefits are provided by the air extraction system 10, 10′ and related method that are the subject matter of this document. Advantageously the air extraction system 10, 10′ incorporates tuned extractor ducts 20, 34 that satisfy the seemingly conflicting goals of providing an unimpeded air flow pathway for the extraction of air from the passenger cabin C and enhanced dissipation of NVH. The cross-sectional area of the extractor ducts 20, 34 meet the appropriate requirements for the extraction of air as set out in the motor vehicle specifications. The ducts 20, 34 provide a discrete airflow pathway dedicated to air extraction so that assemblies, components and sound deadening materials including, for example, sealers and noise insulation cannot be inserted into the airflow pathway impeding or interrupting air extraction through the extractors 16, 32.

At the same time, in order to alleviate the NVH concerns, portions of the ducts 20, 34 are designed with expansion chambers 26, 28, 36, 38, 40 that use a combination of cross-sectional area and length to address specific duct noise frequencies. These expansion chambers 26, 28, 36, 38, 40 may be utilized in series to address multiple noise frequencies and provide additive sound transmission loss. While the embodiment illustrated in FIGS. 1 and 2 includes two expansion chambers 26, 28 and the FIG. 3 embodiment includes three expansions chambers 36, 38, 40, it should be appreciated that the tuned extraction duct 20, 34 may include as few as one and as many as four or more expansion chambers 26, 28, 36, 38, 40 tuned to dissipate noise at different frequencies depending upon application/need.

In the embodiment illustrated in FIG. 3, the extractor duct 34 includes a first expansion chamber 36 having length L₁, a second expansion chamber 38 having a length L₂ and a third expansion chamber 40 having a length L₃ where the third expansion chamber is downstream from the second expansion chamber which is downstream from the first expansion chamber. In one possible employment, L₁>L₂>L₃. In another possible embodiment, L₁>L₃>L₂. In still another possible embodiment, L₂>L₁>L₃. In still another possible embodiment, L₂>L₃>L₁. In yet another possible embodiment, L₃>L₂>L₁. In still another possible embodiment, L₃>L₁>L₂. The ability to vary the lengths of the expansion chambers 36, 38, 40 relative to each other allows some flexibility in designing the extractor duct 34 to better fit within the available and often irregular-shaped spaces within the sheet metal of any particular motor vehicle V.

It should also be appreciated that all of these embodiments provide additive transmission loss to control NVH with the size and shape of the various expansion chamber 36, 38, 40, including, particularly, the length L₁, L₂, L₃ of those chambers, being tuned to provide desired dissipation of duct noise frequencies characteristic of the extractor duct 34. Thus, it should be appreciated that each air extractor system 10, 10′ for a particular motor vehicle is unique and will have its own footprint.

The foregoing has been presented for purposes of illustration and description. It is not intended to be exhaustive or to limit the embodiments to the precise form disclosed. Obvious modifications and variations are possible in light of the above teachings. For example, while the trim air discharge outlet 12 is provided in the package tray 14 in the illustrated embodiment, it should be appreciated that the outlet could be provided in other interior trim components if desired. All such modifications and variations are within the scope of the appended claims when interpreted in accordance with the breadth to which they are fairly, legally and equitably entitled.

What is claimed:

1. An air extraction system for a motor vehicle, comprising:
a trim air discharge outlet;
an extractor; and
an extractor duct extending between said trim air discharge outlet and said extractor, said extractor duct being tuned to dissipate duct noise at at least one particular duct noise frequency characteristic of said extractor duct.

2. The air extraction system of claim 1, wherein said extractor duct includes a first expansion chamber sized and shaped to dissipate duct noise at a first duct noise frequency.

3. The air extraction system of claim 2, wherein said extractor duct includes a second expansion chamber sized and shaped to dissipate duct noise at a second duct noise frequency.

4. The air extraction system of claim 3, wherein said extractor duct includes a third expansion chamber sized and shaped to dissipate duct noise at a third duct noise frequency.

5. The air extraction system of claim 4, wherein said third expansion chamber is downstream from said second expansion chamber and said second expansion chamber is downstream from said first expansion chamber.

6. The air extraction system of claim 5, wherein said first expansion chamber has a length L₁, said second expansion chamber has a length L₂ and said third expansion chamber has a length L₃ where L₁≠L₂≠L₃.

7. The air extraction system of claim 6, wherein L₁>L₂>L₃.

8. The air extraction system of claim 6, wherein L₁>L₃>L₂.

9. The air extraction system of claim 6, wherein L₂>L₁>L₃.

10. The air extraction system of claim 6, wherein L₂>L₃>Lₗ.

11. The air extraction system of claim 6, wherein L₃>L₂>L₁.

12. The air extraction system of claim 6, wherein L₃>L₁>L₂.

13. The air extraction system of claim 1, wherein said trim air discharge outlet is provided in a package tray of the motor vehicle.

14. A method of air extraction from a motor vehicle, comprising:
providing an extractor duct extending from a trim air discharge outlet to an extractor of the motor vehicle; and
tuning said extractor duct to dissipate duct noise at at least one particular duct noise frequency characteristic of said extractor duct.

15. The method of claim 14, including providing a first expansion chamber in said extractor duct, said first expansion chamber being sized and shaped to dissipate duct noise at a first duct noise frequency.

16. The method of claim 15, including providing a second expansion chamber in said extractor duct, said second expansion chamber being sized and shaped to dissipate duct noise at a second duct noise frequency.

17. The method of claim 16, including providing a third expansion chamber in said extractor duct, said third expansion chamber being sized and shaped to dissipate duct noise at a third duct noise frequency.

18. The method of claim 17, including providing said first expansion chamber with a length L₁, said second expansion chamber with a length L₂ and said third expansion chamber with a length L₃ where L₁≠L₂≠L₃.
